(19) United States
(12) Patent Application Publication
(10) Pub. No.: US 2015/0239506 A1
(43) Pub. Date: Aug. 27, 2015

(54) VEHICLE FENDER GUARD

(71) Applicant: Mike GUST, Houston, TX (US)

(72) Inventor: Mike GUST, Houston, TX (US)

(21) Appl. No.: 14/633,333

(22) Filed: Feb. 27, 2015

Related U.S. Application Data
(60) Provisional application No. 61/945,322, filed on Feb. 27, 2014.

(51) Int. Cl. B62D 25/18; B23P 19/04; B62D 65/16

(52) U.S. Cl. CPC B62D 25/18; B62D 65/16; B23P 19/04

(57) ABSTRACT

Systems and methods for a fender guard are described. The fender guard comprises a first end and a second end, and at least one radius of curvature between the first end and the second end. The at least one radius of curvature is configured to conform with a contour of a fender. The system includes at least one attachment device that is configured to secure the fender guard to a region of the fender. The fender guard is configured to support and/or protect the region when secured to the region.

### RELATED APPLICATION

This application claims the benefit of United States U.S. patent application Ser. No. 61/945,322, filed Feb. 27, 2014.

### TECHNICAL FIELD

The embodiments described herein relate to vehicle components and, more particularly, to a fender guard for a vehicle.

### BACKGROUND

There is a need for a vehicle fender guard that strengthens and protects any fender to which it is attached.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1 is a schematic of a vehicle fender guard for attachment to a host vehicle, under an embodiment.

FIG. 2 is a schematic of a vehicle fender guard for attachment to a host vehicle, under an alternative embodiment.

### DETAILED DESCRIPTION

Systems and methods for a fender guard are described. The fender guard comprises a first end and a second end, and at least one radius of curvature between the first end and the second end. The at least one radius of curvature is configured to conform with a contour of a fender. The system includes at least one attachment device that is configured to secure the fender guard to a region of the fender. The fender guard is configured to support and/or protect the region when secured to the region.

In the following description, numerous specific details are introduced to provide a thorough understanding of, and enabling description for, the systems and methods described. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

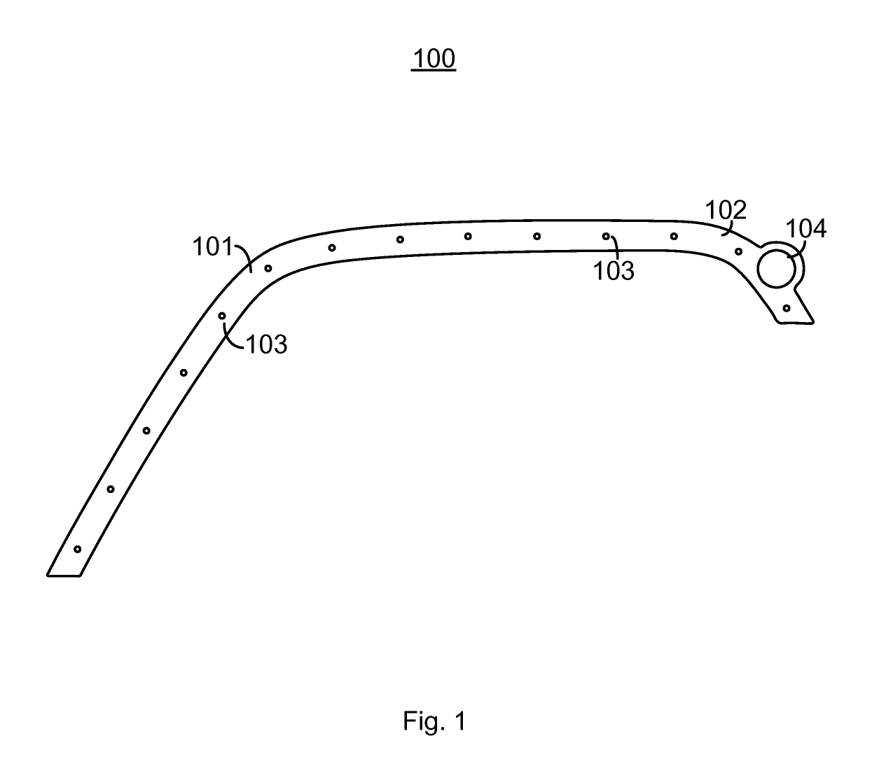

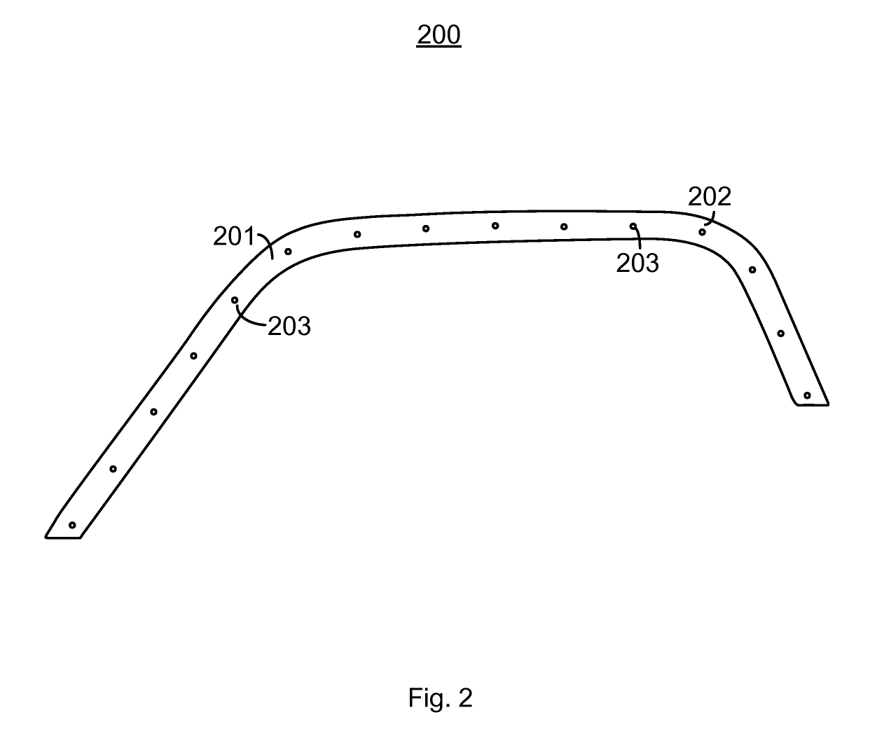

FIG. 1 is a schematic of a fender guard 100 for attachment to a host vehicle, under an embodiment. FIG. 2 is a schematic of a fender guard 200 for attachment to a host vehicle, under an alternative embodiment. While the schematic of the vehicle fender guard 100/200 of this example includes representative dimensions, the embodiments are not limited to these dimensions. Generally, the vehicle fender guard 100/200, also referred to as a fender guard or fender guard assembly, has a configuration that is bowed, arched, curved, semi-curved, and/or compound curved, and includes, accommodates, or receives an attachment mechanism. For example, the fender guard 100/200 of an embodiment includes two radii of curvature 101/201 and 102/202, but is not so limited. The size and configuration of the fender guard 100/200 is as appropriate to the size and configuration of the target mounting location on the vehicle. The vehicle of an embodiment includes a motor vehicle, for example one or more of an automobile, car, truck, off-road vehicle, and all terrain vehicle, to name a few, but is not limited to motor vehicles.

The fender guard 100/200 of an embodiment is made of a material appropriate to the target attaching location of the host vehicle and an attachment method used for attaching it to the vehicle. For example, the fender guard 100/200 comprises one or more of plastic, composite, polymer, metal, and alloy to name a few, but is not so limited. The fender guard 100/200 of an embodiment is provided in one or more colors (e.g., custom colors, original equipment manufacturer colors, etc.). Alternatively, the fender guard 100/200 is paintable before or after installation.

Generally, the fender guard 100/200 is configured to attach, connect or couple to a fender or fender structure of a vehicle using an attachment mechanism. As one example, the fender guard 100/200 of an embodiment is attached to the fender adjacent the outermost edge or surface of the fender, and matches or follows the contour of the portion of the fender to which it is attached. The fender guard 100/200 is attached to the vehicle fender, or to a component of the vehicle fender, using an attachment method or mechanism as appropriate to the configuration of the fender and the fender guard. The attachment mechanisms include, for example, one or more of rivets, screws, bolts, studs, nuts, epoxy materials, glue, and welds, but the mechanisms are not so limited. Example embodiments of the fender guard 100/200 include orifices 103/203 configured to receive attachment mechanisms (e.g., screws, rivets, bolts, etc.) that secure to the fender guard to the fender, but the embodiments are not so limited.

The fender guard 100 of an embodiment is configured to conform with any structures in the region of the fender to which the fender guard is secured. For example, the fender guard of an example includes a region 104 configured to accommodate a vehicle marker light, but the embodiment is not so limited. Various other vehicle structures are accommodated by the configuration of the fender guard 100/200 described herein.

The fender guard 100/200, when attached to the host vehicle, provides one or more of support and protection for an adjacent component or portion of the vehicle. The fender guard 100/200 is attached to a pre-specified region of a fender of the host vehicle. As such, a fender guard 100/200 is attached to each fender of a vehicle as appropriate to the vehicle configuration (e.g., a vehicle having four wheels, with four fenders, would include four fender guards, etc.).

The fender guard 100/200 of an embodiment is provided separately, along with materials appropriate to an attachment method. The fender guard 100/200 of an alternative embodiment is provided in a kit with one or more other fender guards appropriate to the host vehicle.

Embodiments described herein include a system comprising a fender guard comprising a first end and a second end. The fender guard comprises at least one radius of curvature between the first end and the second end. The at least one radius of curvature is configured to conform with a contour of a fender. The system includes at least one attachment device that is configured to secure the fender guard to a region of the fender. The fender guard is configured to support and/or protect the region when secured to the region.

Embodiments described herein include a system comprising: a fender guard comprising a first end and a second end, wherein the fender guard comprises a at least one radius of curvature between the first end and the second end, wherein the at least one radius of curvature is configured to conform with a contour of a fender; and at least one attachment device that is configured to secure the fender guard to a region of the fender, wherein the fender guard is configured to at least one of support and protect the region when secured to the region.

The region comprises a region adjacent an outermost edge or surface of the fender.

The region comprises at least one lengthwise section of the fender.

The fender guard comprises at least one of plastic, composite, polymer, metal, and alloy.

The at least one attachment device includes at least one of rivets, screws, bolts, studs, nuts, epoxy materials, glue, and welds.

Embodiments described herein include a system comprising a plurality of fender guards. Each fender guard comprises a first end and a second end separated by a medial region having at least one radius of curvature. The at least one radius of curvature of each fender guard is configured to conform with a contour of a fender corresponding to the fender guard. The system includes a plurality of attachment devices configured to secure each fender guard of the plurality of fender guards to a region of a corresponding fender. Each fender guard is configured to at least one of support and protect the region of the corresponding fender when secured to the region.

Embodiments described herein include a system comprising: a plurality of fender guards, wherein each fender guard comprises a first end and a second end separated by a medial region having at least one radius of curvature, wherein the at least one radius of curvature of each fender guard is configured to conform with a contour of a fender corresponding to the fender guard; and a plurality of attachment devices configured to secure each fender guard of the plurality of fender guards to a region of a corresponding fender, wherein each fender guard is configured to at least one of support and protect the region of the corresponding fender when secured to the region.

The region comprises a region adjacent an outermost edge or surface of the corresponding fender.

The region comprises at least one lengthwise section of the corresponding fender.

Each fender guard comprises at least one of plastic, composite, polymer, metal, and alloy.

The plurality of attachment devices includes at least one of rivets, screws, bolts, studs, nuts, epoxy materials, glue, and welds.

Embodiments described herein include a method comprising forming a fender guard to include a first end and a second end separated by a medial region having at least one radius of curvature. The at least one radius of curvature is configured to conform with a contour of a fender. The method comprises securing the fender guard to a region of the fender using at least one attachment device. The fender guard is configured to support and/or protect the region when secured to the region.

Embodiments described herein include a method comprising: forming a fender guard to include a first end and a second end separated by a medial region having at least one radius of curvature, wherein the at least one radius of curvature is configured to conform with a contour of a fender; and securing the fender guard to a region of the fender using at least one attachment device, wherein the fender guard is configured to at least one of support and protect the region when secured to the region.

The region comprises a region adjacent an outermost edge or surface of the fender.

The region comprises at least one lengthwise section of the fender.

The forming of the fender guard comprises forming the fender guard to include at least one of plastic, composite, polymer, metal, and alloy.

The at least one attachment device includes at least one of rivets, screws, bolts, studs, nuts, epoxy materials, glue, and welds.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the systems and methods is not intended to be exhaustive or to limit the systems and methods to the precise forms disclosed. While specific embodiments of, and examples for, the systems and methods are described herein for illustrative purposes, various equivalent modifications are possible within the scope of the systems and methods, as those skilled in the relevant art will recognize. The teachings of the systems and methods provided herein can be applied to other systems and methods, not only for the systems and methods described above.

The elements and acts of the various embodiments described above can be combined to provide further embodiments. These and other changes can be made to the systems and methods in light of the above detailed description.

What is claimed is:

1. A system comprising:
a fender guard comprising a first end and a second end, wherein the fender guard comprises at least one radius of curvature between the first end and the second end, wherein the at least one radius of curvature is configured to conform with a contour of a fender; and
at least one attachment device that is configured to secure the fender guard to a region of the fender, wherein the fender guard is configured to at least one of support and protect the region when secured to the region.

2. The system of claim 1, wherein the region comprises a region adjacent an outermost edge or surface of the fender.

3. The system of claim 1, wherein the region comprises at least one lengthwise section of the fender.

4. The system of claim 1, wherein the fender guard comprises at least one of plastic, composite, polymer, metal, and alloy.

5. The system of claim 1, wherein the at least one attachment device includes at least one of rivets, screws, bolts, studs, nuts, epoxy materials, glue, and welds.

6. A system comprising:
a plurality of fender guards, wherein each fender guard comprises a first end and a second end separated by a medial region having at least one radius of curvature, wherein the at least one radius of curvature of each fender guard is configured to conform with a contour of a fender corresponding to the fender guard; and
a plurality of attachment devices configured to secure each fender guard of the plurality of fender guards to a region of a corresponding fender, wherein each fender guard is configured to at least one of support and protect the region of the corresponding fender when secured to the region.

7. The system of claim 6, wherein the region comprises a region adjacent an outermost edge or surface of the corresponding fender.

8. The system of claim 6, wherein the region comprises at least one lengthwise section of the corresponding fender.

9. The system of claim 6, wherein each fender guard comprises at least one of plastic, composite, polymer, metal, and alloy.

10. The system of claim 6, wherein the plurality of attachment devices includes at least one of rivets, screws, bolts, studs, nuts, epoxy materials, glue, and welds.

11. A method comprising:
forming a fender guard to include a first end and a second end separated by a medial region having at least one radius of curvature, wherein the at least one radius of curvature is configured to conform with a contour of a fender; and
securing the fender guard to a region of the fender using at least one attachment device, wherein the fender guard is configured to at least one of support and protect the region when secured to the region.

12. The method of claim 11, wherein the region comprises a region adjacent an outermost edge or surface of the fender.

13. The method of claim 11, wherein the region comprises at least one lengthwise section of the fender.

14. The method of claim 11, wherein the forming of the fender guard comprises forming the fender guard to include at least one of plastic, composite, polymer, metal, and alloy.

15. The method of claim 11, wherein the at least one attachment device includes at least one of rivets, screws, bolts, studs, nuts, epoxy materials, glue, and welds.
